(19) United States
(12) Patent Application Publication
(10) Pub. No.: US 2026/0116445 A1
(43) Pub. Date: Apr. 30, 2026

(54) CART CAPABLE OF BEING FOLDED WITHOUT ELEVATING CART FRAME AND PROVIDED WITH CONNECTING POLES

(71) Applicant: Zhejiang Pride Leisure Products Co,. Ltd., Jinhua (CN)

(72) Inventor: Benlong SUN, Jinhua (CN)

(21) Appl. No.: 19/376,878

(22) Filed: Oct. 31, 2025

(30) Foreign Application Priority Data
Oct. 31, 2024 (CN) 202422656545.X

(51) Int. Cl. B62B 3/00; B62B 3/02; B62B 5/06

(52) U.S. Cl. CPC B62B 3/007; B62B 3/025; B62B 5/065; B62B 2205/06

(57) ABSTRACT

A cart capable of being folded without elevating a cart frame and provided with connecting poles. A cart frame having four vertical poles, vertical folding frames located at front and rear ends and hinged to the vertical poles, a plurality of pairs of bottom folding frames and horizontal folding frames hinged to the vertical poles, and a plurality of connecting poles located on two sides, and adjacent horizontal folding frames and bottom folding frames are hinged to the connecting poles. Fixing blocks are mounted at top ends of the vertical poles and top ends of the connecting poles, movable sliders are arranged on the vertical poles and the connecting poles, and lower ends of outer sides of the horizontal folding frames and the vertical folding frames are hinged to the sliders.

### BACKGROUND OF THE INVENTION

### 1. Technical Field

The disclosure relates to the technical field of carts, in particular to a cart capable of being folded without elevating a cart frame and provided with connecting poles.

### 2. Description of Related Art

Outdoor activities are becoming more and more popular and have become fashionable leisure activities. In most outdoor activities, a great many personal articles and articles for activities need to be carried. After driving to a desired place, people have to manually carry these articles to the destination, which is not only time-consuming and labor-consuming, but also destroys the atmosphere of the outdoor activity. In view of this, folding carts are developed, and articles can be placed on the folding carts to be pulled to the destination, such that time and labor are saved. In addition, the folding carts can be folded when not used, thus occupying a small space and being easy to carry.

Chinese Patent Application No. CN218858468U discloses a standing type folding cart, which comprises a bottom frame cross-support, wherein bottom frame bodies are arranged on two sides of the bottom frame cross-support, folding frames are hinged to outer sides of the bottom frame bodies by means of hinges, a fixing frame is arranged at the top of the bottom frame cross-support, a handle is mounted at the top of the fixing frame, standing links are mounted on the outer sides of the bottom frame bodies, metal supports are arranged at bottoms of the bottom frame bodies, wheels are hinged into the metal supports by means of hinges, standing legs are arranged on outer sides of the metal supports, standing support devices extending to the outside are arranged inside the standing legs, movable frames are arranged on outer sides of the folding frames, and reinforcing rods are hinged between inner walls of two sides of the folding frames by means of hinges.

The folding cart can be folded by means of the folding frames on left and right sides, but the cart frames on front and back sides cannot be folded, so the folding cart cannot be completely folded and still occupies a large space after being folded, leading to moderate user experience.

### BRIEF SUMMARY OF THE INVENTION

To overcome the defects in the prior art, the disclosure provides a cart capable of being folded without elevating a cart frame and provided with connecting poles. To solve the abovementioned technical problems, the disclosure provides the following technical solution.

A cart capable of being folded without elevating a cart frame and provided with connecting poles comprises a cart frame and casters mounted at a bottom of the cart frame, wherein the cart frame comprises four vertical poles, vertical folding frames located at front and rear ends of the cart frame and hinged to the vertical poles, and a plurality of pairs of bottom folding frames and horizontal folding frames hinged to the vertical poles, and the cart frame is folded by folding the vertical folding frames, the bottom folding frames and the horizontal folding frames; and the cart frame further comprises a plurality of connecting poles located on two sides of the cart frame, and adjacent horizontal folding frames and bottom folding frames are hinged to the connecting poles;
fixing blocks are mounted at top ends of the vertical poles and top ends of the connecting poles, movable sliders are arranged on the vertical poles and the connecting poles, lower ends of outer sides of the horizontal folding frames and the vertical folding frames are hinged to the sliders, and upper ends of the outer sides of the horizontal folding frames and the vertical folding frames are hinged to the fixing blocks, and the sliders slide vertically to drive the horizontal folding frames and the vertical folding frames to be folded or unfolded.

Further, each horizontal folding frame comprises two horizontal rods, centers of the two horizontal rods are movably riveted, the horizontal rods are able to rotate around a rivet point to be folded or unfolded; and each horizontal rod has an end hinged to the corresponding fixing block and an end hinged to the corresponding slider.

Further, each vertical folding frame comprises two X-frames that are hinged together, each X-frame comprises two vertical rods, centers of the two vertical rods are movably riveted, and the vertical rods are able to rotate around a rivet point to be folded or unfolded; and inner ends of the vertical rods are hinged together to connect the two X-frames, and outer ends of the vertical rods are hinged to the corresponding fixing blocks and the corresponding sliders respectively.

Further, the bottom folding frame comprises a connecting base at a center and a plurality of bottom rods, and inner ends of the bottom rods are hinged to the connecting base.

Further, fasteners are arranged at bottoms of the vertical poles and bottoms of the connecting poles, and outer ends of the bottom rods are hinged into the fasteners.

Further, a plurality of hinge notches which are open downwards are formed in the connecting base, and the bottom rods are hinged into the hinge notches.

Further, a foldable handle frame is arranged at the front end of the cart frame and hinged to the fasteners at the front end of the cart frame.

Further, the handle frame comprises a fixing base, connecting rods hinged to two sides of the fixing base, and a telescopic pull rod mounted on the fixing base, connecting pieces are hinged to ends of the connecting rods, and the connecting pieces are hinged to the fasteners.

Further, a grip ring is arranged at a top end of the pull rod.

Further, brake pedals are arranged at the front end of the cart frame and located above the casters at the front end of the cart frame.

Compared with the prior art, the disclosure fulfills the following beneficial effects:

In the disclosure, the cart frame comprises the four vertical poles, the vertical folding frames located at the front and rear ends of the cart frame and hinged to the vertical poles, and the three pairs of bottom folding frames and horizontal folding frames hinged to the vertical poles, and when the vertical folding frames, the bottom folding frames and the horizontal folding frames are folded, the four vertical poles are driven to move towards the center, such that the cart frame is folded. Four sides of the cart frame can be folded, such that the size of the cart in the folded state is further reduced, and the cart can be easily carried outdoors by users and can also be easily packaged and delivered by manufacturers. The cart frame further comprises the plurality of connecting poles located on the two sides of the cart frame, two connecting poles are arranged on each side of the cart frame, and the adjacent horizontal folding frames and bottom folding frames are hinged to the connecting poles, such that the carrying capacity of the cart frame is improved, and the stability of the cart frame is also improved.

### BRIEF DESCRIPTION OF THE SEVERAL VIEWS OF THE DRAWINGS

FIG. 1 is a perspective view according to the disclosure.

FIG. 2 is a back view according to the disclosure.

FIG. 3 is a side view according to the disclosure.

FIG. 4 is a bottom view according to the disclosure.

Reference signs: 1, cart frame; 2, caster; 3, vertical pole; 4, vertical folding frame; 5, horizontal folding frame; 6, bottom folding frame; 7, fixing block; 8, slider; 9, connecting pole; 110, horizontal rod; 11, X-frame; 12, vertical rod; 13, connecting base; 14, bottom rod; 15, fastener; 16, hinge notch; 17, handle frame; 18, fixing base; 19, pull rod; 20, connecting rod; 21, connecting piece; 22, grip ring; 23, brake pedal.

### DETAILED DESCRIPTION OF THE INVENTION

The technical solutions in the embodiments of the disclosure are clearly and completely described below in conjunction with accompanying drawings of these embodiment. Obviously, the embodiments in the following description are merely illustrative ones and are not all possible ones of the disclosure. All other embodiments obtained by those skilled in the art based on the following ones without creative labor should also fall within the protection scope of the disclosure.

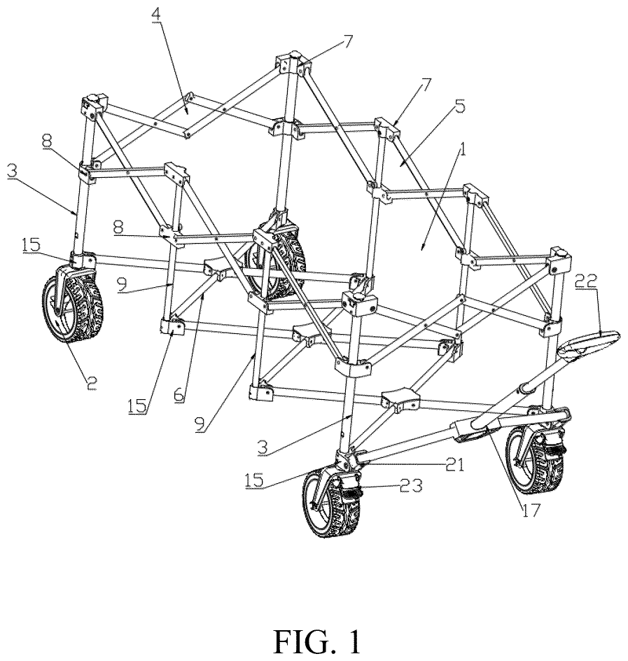

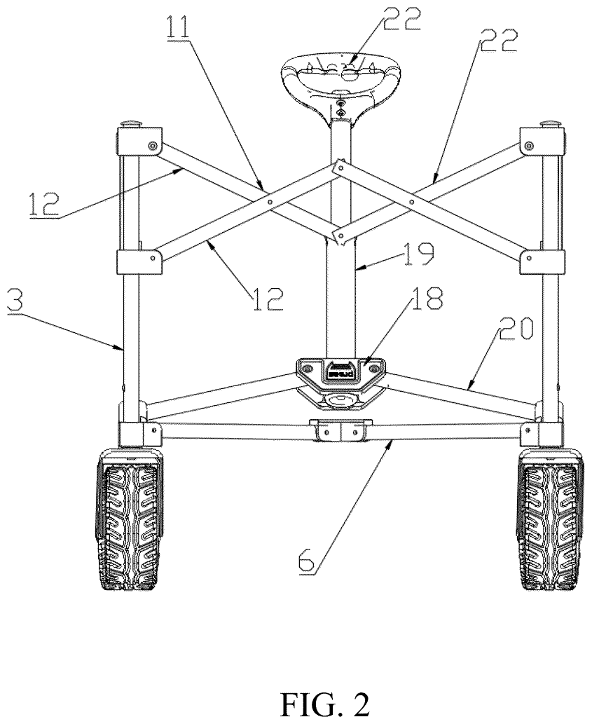

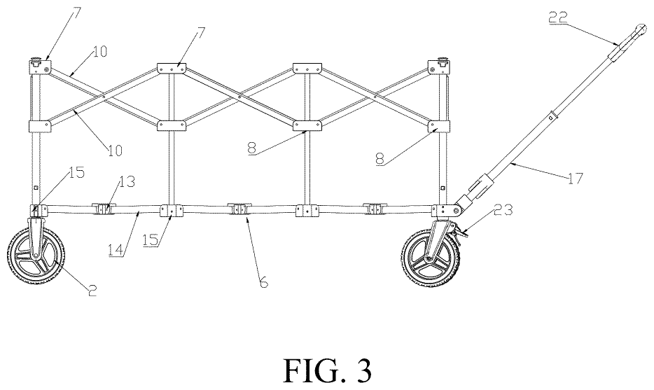

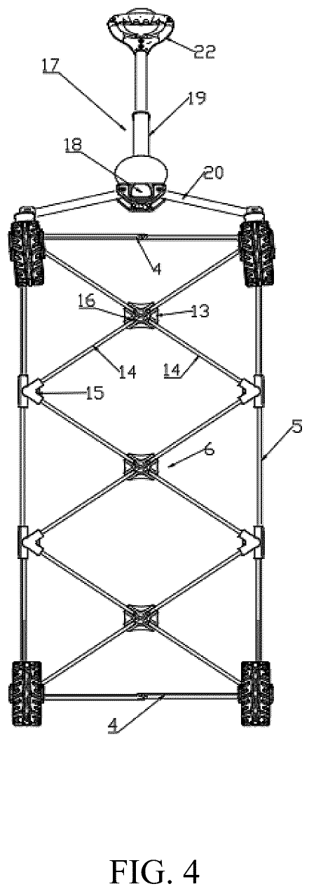

As shown in FIGS. 1-4, a cart capable of being folded without elevating a cart frame and provided with connecting poles comprises a cart frame 1 and casters 2 mounted at the bottom of the cart frame 1, wherein the cart frame 1 comprises four vertical poles 3, vertical folding frames 4 located at front and rear ends of the cart frame 1 and hinged to the vertical poles 4, and three pairs of bottom folding frames 6 and horizontal folding frames 5 hinged to the vertical poles, and when the vertical folding frames 4, the bottom folding frames 6 and the horizontal folding frames 5 are folded, the four vertical poles 3 are driven to move towards the center, such that the cart frame 1 is folded. Four sides of the cart frame 1 can be folded, such that the size of the cart in the folded state is further reduced, and the cart can be easily carried outdoors by users and can also be easily packaged and delivered by manufacturers. The cart frame 1 further comprises a plurality of connecting poles 9 located on two sides of the cart frame 1, wherein two connecting poles 9 are arranged on each side of the cart frame 1, and the adjacent horizontal folding frames 5 and bottom folding frames 6 are hinged to the connecting poles 9, such that the carrying capacity of the cart frame 1 is improved, and the stability of the cart frame is also improved.

Fixing blocks 7 are mounted at top ends of the vertical poles 3 and top ends of the connecting poles 9, movable sliders 9 are arranged on the vertical poles 3 and the connecting poles 9, lower ends of outer sides of the horizontal folding frames 5 and the vertical folding frames 4 are hinged to the sliders 8, and upper ends of the outer sides of the horizontal folding frames 5 and the vertical folding frames 4 are hinged to the fixing blocks 7. The sliders 8 can slide downwards to drive the horizontal folding frames 5 and the vertical folding frames 4 to be folded without elevating the vertical poles 3 and the connecting poles 9, such that the space occupied by the cart is reduced, and the cart can be packaged easily.

Each horizontal folding frame 5 comprises two horizontal rods 10, wherein centers of the two horizontal rods 10 are movably riveted, and the two horizontal rods 10 are able to rotate around a rivet point to be folded or unfolded, such that the structure is simple. One end of each horizontal rod 10 is hinged to the corresponding fixing block 7, and the other end of each horizontal rod 10 is hinged to the corresponding slider 8.

Each vertical folding frame 4 comprises two X-frames 11 that are hinged together, each X-frame 11 comprises two vertical rods 12, centers of the two vertical rods 12 are movably riveted, and the vertical rods 12 are able to rotate around a rivet point to be folded or unfolded; and inner ends of the vertical rods 12 are hinged together to connect the two X-frames 11, and outer ends of the vertical rods 12 are hinged to the corresponding fixing blocks 7 and the corresponding sliders 8 respectively. When the cart frame is folded, the horizontal rods 10 and the vertical rods 12 rotate downwards, the fixing blocks 7 at the upper ends will not move, and the sliders 8 at the lower ends will slide downwards to fold the cart frame; similarly, when the cart fold is unfolded, the horizontal rods 10 and the vertical rods 12 rotate upwards to drive the sliders to slide upwards.

The bottom folding frame 6 comprises a connecting base 13 at the center and four bottom rods 14, and inner ends of the bottom rods 14 are hinged to the connecting base 1. Fasteners 15 are arranged at bottoms of the vertical poles 3 and bottoms of the connecting poles 9, outer ends of the bottom rods 14 are hinged into the fasteners 15. When the cart frame is folded, the connecting base 13 moves upwards and drives the vertical poles 3 and the connecting poles 9 to be folded by means of the bottom rods 14, and the four bottom rods 14 rotate upwards to be folded.

The connecting base 13 is provided with four hinge notches 16 that are open downwards, and the bottom rods 14 are hinged into the hinge notches 16. Because the hinge notches 16 are open downwards, the bottom rods 14 can only rotate downwards, such that the situation that the bottom rods are folded reversely due to a downward pressure applied by goods on the cart frame 1 is avoided. The cart can be folded by pulling the connecting base 13 upwards.

A foldable handle frame 17 is arranged at the front end of the cart frame, and the handle frame 17 can be folded or unfolded synchronously with the cart frame 1, such that the cart can be stored and packaged easily. The handle frame 17 is hinged into the fasteners 15 at the front end of the cart frame 1, and the handle frame 17 is telescopic and can be adjusted to a suitable position according to the height and position of different users so as to be used by the users.

The handle frame 17 comprises a fixing base 18, connecting rods 20 hinged to two sides of the fixing base, and a telescopic pull rod 19 mounted on the fixing base, and the pull rod 19 is able to telescopic by means of two rods with one being inserted into the other. Connecting pieces 21 are hinged to ends of the connecting rods 20 and are hinged to the corresponding fasteners, and the handle frame 17 can rotate by means of the connecting rods 21. When the handle frame 17 is folded, the vertical poles 3 on two sides are folded to drive the two connecting rods 20 to rotate downwards with the fixing base 18 as the center, and the fixing base 18 moves upwards; and when the handle frame 17 is unfolded, the fixing base 18 moves downwards, and the vertical poles 3 on the two sides drive the connecting rods 20 to rotate to be unfolded.

A grip ring 22 is arranged at the top end of the pull rod 19, and users pull the cart by gripping the grip ring 22. Brake pedals 23 are arranged at the front end of the cart frame 1 and located above the two wheels 2 at the front end, and users can step on the brake pedals 23 to brake the folding cart, such that the situation that users cannot stop the cart due to a large inertia is avoided.

It is obvious for those skilled in the art that the disclosure is not limited to the details of the illustrative embodiments described above and can be implemented in other specific forms without departing from the spirit or basic features of the disclosure. Therefore, from any perspective, the above embodiments should be construed as illustrative rather than restrictive. The scope of the disclosure should be defined by the appended claims rather than the above description. Therefore, all variations falling within the concept and scope of equivalents of the claims should be included in the disclosure. Any reference sign in the claims should not be construed as a limitation of the claims involved.

What is claimed is:

1. A cart capable of being folded without elevating a cart frame and provided with connecting poles, comprising:
a cart frame and casters mounted at a bottom of the cart frame, wherein the cart frame comprises four vertical poles, vertical folding frames located at front and rear ends of the cart frame and hinged to the vertical poles, and a plurality of pairs of bottom folding frames and horizontal folding frames hinged to the vertical poles;
wherein the cart frame is folded by folding the vertical folding frames, the bottom folding frames and the horizontal folding frames; and
wherein the cart frame further comprises a plurality of connecting poles located on two sides of the cart frame, and adjacent said horizontal folding frames and bottom folding frames are hinged to the connecting poles;
a plurality of fixing blocks are mounted at top ends of the vertical poles and top ends of the connecting poles;
a plurality of movable sliders are arranged on the vertical poles and the connecting poles, lower ends of outer sides of the horizontal folding frames and the vertical folding frames are hinged to the sliders;
wherein upper ends of the outer sides of the horizontal folding frames and the vertical folding frames are hinged to the fixing blocks; and
wherein the sliders slide vertically to drive the horizontal folding frames and the vertical folding frames to be folded or unfolded.

2. The cart capable of being folded without elevating a cart frame and provided with connecting poles according to claim 1, wherein each said horizontal folding frame comprises two horizontal rods, centers of the two horizontal rods are movably riveted, the horizontal rods are able to rotate around a rivet point to be folded or unfolded; and each said horizontal rod has an end hinged to the corresponding fixing block and an end hinged to the corresponding slider.

3. The cart capable of being folded without elevating a cart frame and provided with connecting poles according to claim 1, wherein each said vertical folding frame comprises two X-frames that are hinged together, each said X-frame comprises two vertical rods, centers of the two vertical rods are movably riveted, and the vertical rods are able to rotate around a rivet point to be folded or unfolded; and inner ends of the vertical rods are hinged together to connect the two X-frames, and outer ends of the vertical rods are hinged to the corresponding fixing blocks and the corresponding sliders respectively.

4. The cart capable of being folded without elevating a cart frame and provided with connecting poles according to claim 1, wherein the bottom folding frame comprises a connecting base at a center and a plurality of bottom rods, and inner ends of the bottom rods are hinged to the connecting base.

5. The cart capable of being folded without elevating a cart frame and provided with connecting poles according to claim 4, wherein fasteners are arranged at bottoms of the vertical poles and bottoms of the connecting poles, and outer ends of the bottom rods are hinged into the fasteners.

6. The cart capable of being folded without elevating a cart frame and provided with connecting poles according to claim 4, wherein a plurality of hinge notches which are open downwards are formed in the connecting base, and the bottom rods are hinged into the hinge notches.

7. The cart capable of being folded without elevating a cart frame and provided with connecting poles according to claim 5, wherein a foldable handle frame is arranged at the front end of the cart frame and hinged to the fasteners at the front end of the cart frame.

8. The cart capable of being folded without elevating a cart frame and provided with connecting poles according to claim 7, wherein the handle frame comprises a fixing base, connecting rods hinged to two sides of the fixing base, and a telescopic pull rod mounted on the fixing base, connecting pieces are hinged to ends of the connecting rods, and the connecting pieces are hinged to the fasteners.

9. The cart capable of being folded without elevating a cart frame and provided with connecting poles according to claim 8, wherein a grip ring is arranged at a top end of the pull rod.

10. The cart capable of being folded without elevating a cart frame and provided with connecting poles according to claim 1, wherein brake pedals are arranged at the front end of the cart frame and located above the casters at the front end of the cart frame.
